(19) United States
(12) Patent Application Publication
(10) Pub. No.: US 2003/0033970 A1
(43) Pub. Date: Feb. 20, 2003

(54) Whistle with cushioned mouthpiece

(76) Inventors: Graham Hills, Hamilton (CA); Kirk Mosna, Ancaster (CA); Steve Orzel, Hamilton (CA); Ronald Foxcroft, Burlington (CA)

Correspondence Address: INGRID E. SCHMIDT, GOWLING LAFLEUR HENDERSON LLP, SUITE 560-120 KING STREET WEST, PO BOX 1045 LCD 1, HAMILTON, ON, L8N 3R4, CA

(21) Appl. No.: 09/931,886

(22) Filed: Aug. 20, 2001

(51) Int. Cl. G10K 5/00

(52) U.S. Cl. 116/137 R; 446/202; 446/216

(57) ABSTRACT

A whistle has a mouthpiece which is cushioned to minimize damage to the whistle and improve the comfort and safety of a user. The cushioning material is preferably injection moulded into a sleeve which locates between ridges integrally moulded with the whistle body. The body also has a plurality of projections for mating with the cushioning material. A web in an air inlet passage strengthens the mouthpiece to prevent collapse or fracture of the mouthpiece.

### FIELD OF THE INVENTION

This invention relates to a mouthpiece for a whistle, the mouthpiece being the portion of a whistle which is positioned in the mouth when the whistle is in use.

### BACKGROUND OF THE INVENTION

Whistles are normally used to alert other people that there is a danger or that some corrective action is required, such as while playing sports. The mouthpiece therefore is subject to abuse, particularly where the danger is eminent or the level of play is tense. Commonly, the user will bear down on the mouthpiece with the teeth and could, in some cases, damage the whistle or the teeth, or both.

It has therefore been found desirable to add a cushioned layer to the mouthpiece so as to soften the mouthpiece and minimize any impact between the whistle mouthpiece and the teeth.

An object of this invention is to further improve the durability of such a whistle with a cushioned mouthpiece and to maximize the comfort and safety of the user.

### SUMMARY OF THE INVENTION

In accordance with the invention, there is provided a whistle having a cushioned mouthpiece wherein the mouthpiece is covered with an elastomeric material or suitable equivalent cushioning material which is located between confining ridges formed with the mouthpiece. The cushioning material is preferably injection moulded onto the whistle body and the whistle has a plurality of projections for mating with the cushioning material and to better locate the cushioning material. In a preferred embodiment of the invention, the whistle body has a strengthening web disposed inside the mouthpiece to support upper and lower portions and minimize the likelihood of whistle portions collapsing or fracturing.

### BRIEF DESCRIPTION OF THE DRAWINGS

A preferred embodiment of the invention is described below with reference to the drawings, in which:

FIG. 1 is a perspective view from the top of a whistle incorporating a cushioned mouthpiece in accordance with the invention;

FIGS. 2a to 2c are side elevation views showing three component mouldings forming part of the whistle of FIG. 1;

FIG. 3 (drawn adjacent FIG. 1) is a perspective view from the top of a first moulding forming part of the whistle of FIG. 1;

FIG. 4 (drawn adjacent FIG. 3) is a perspective view from the bottom of a second moulding forming part of the whistle of FIG. 1;

FIG. 5 is a cross-sectional view drawn on line 5-5 of FIG. 1;

FIG. 6 is a cross-sectional view drawn on line 6-6 of FIG. 1;

FIG. 7 is a perspective view from the top of the second moulding drawn in FIG. 4; and

FIGS. 8 to 11 are similar views of FIG. 1 showing alternative configurations for the cushioned mouthpiece associated with respective whistles and forming part of the invention.

### DESCRIPTION OF PREFERRED EMBODIMENT WITH REFERENCE TO THE DRAWINGS

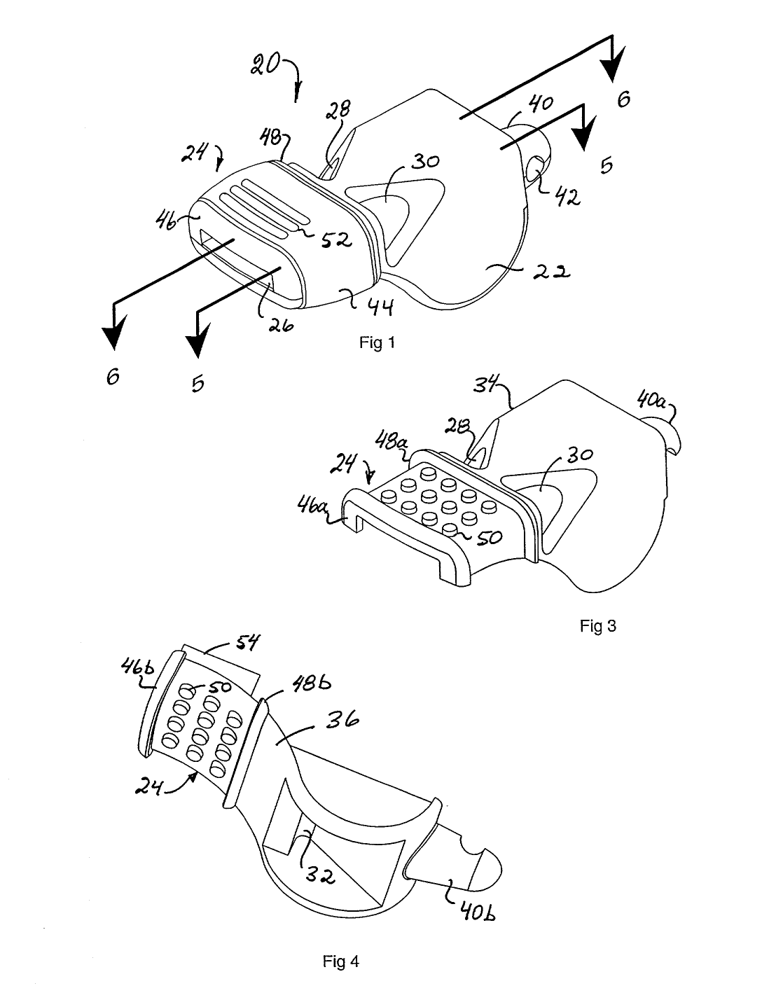

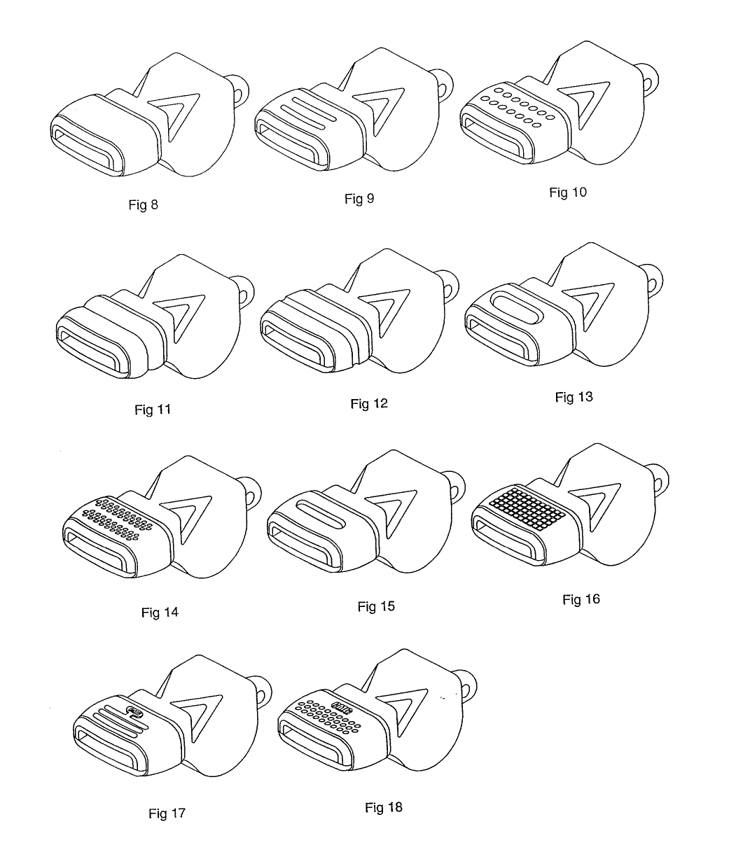

A preferred embodiment of the invention will now be described to FIGS. 1 to 7, with additional embodiments being illustrated in FIGS. 8 to 18.

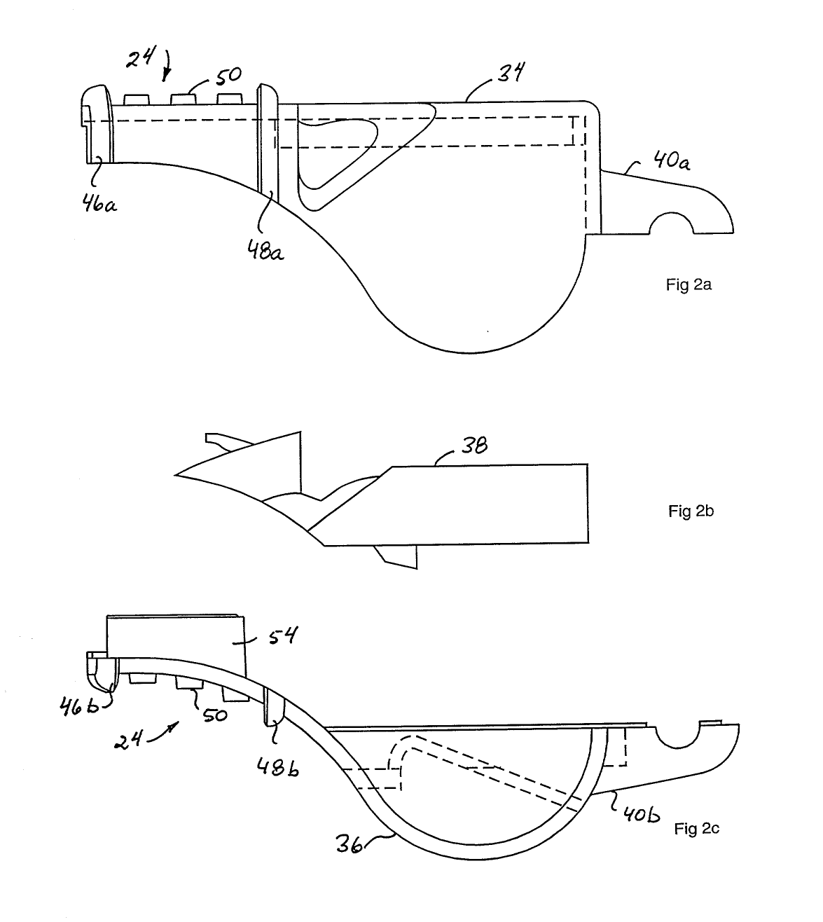

The whistle is generally indicated in the drawings by reference numeral 20 and comprises a synthetic plastic injection moulded body 22 which, in accordance with the preferred embodiment, has been fabricated from three component parts shown in FIGS. 2a, 2b, 2c in accordance with U.S. Pat. Nos. 4,821,670 and 5,816,186, the disclosures of which are herein incorporated by reference. The whistle body 22 is characterized in that it does not contain a piece which may otherwise become jammed in an air passage and, as a result, the whistle would cease to produce a sound. Instead, the whistle has three harmonically tuned air chambers to create a wave energy phenomenon. As a result, the whistle which is marketed under the registered trademark FOX 40® produces an extremely loud, highly penetrating “trill”. It will however be understood that the invention may be applied to other forms and styles of whistle bodies.

Returning to FIG. 1, it will be seen that the whistle 20 has a mouthpiece 24 (drawn to the left of the figure) which defines an air inlet passage 26 through which air will flow and exit from three air chambers 28, 30, 32. Two of the air chambers 28, 30 are visible in a top component 34 forming the whistle body 22, while the third chamber 32 is visible in a bottom component 36 of the whistle body 22, both of which are shown in FIGS. 3 and 4 respectively and drawn adjacent FIG. 1. FIG. 2a, 2b, 2c may collectively be understood as an exploded side elevation view of the whistle body 22 from it will be seen that the whistle body further includes a middle component 38 which in use is disposed between the top component 34 and the bottom component 36 and which is shaped to define the aforementioned air chambers 28, 30, 32. A central boss 40 is formed in the body 22 of the whistle at an end opposite from the mouthpiece 24 by bringing together respective components 40a, 40b formed in the top component 34 of the whistle body and the bottom component 36 of the whistle body. Each component 40a, 40b of the boss 40 is formed with an arcuate groove to define an opening 42 which in use may receive a ring clip for securing a lanyard or other fastener to the whistle 20.

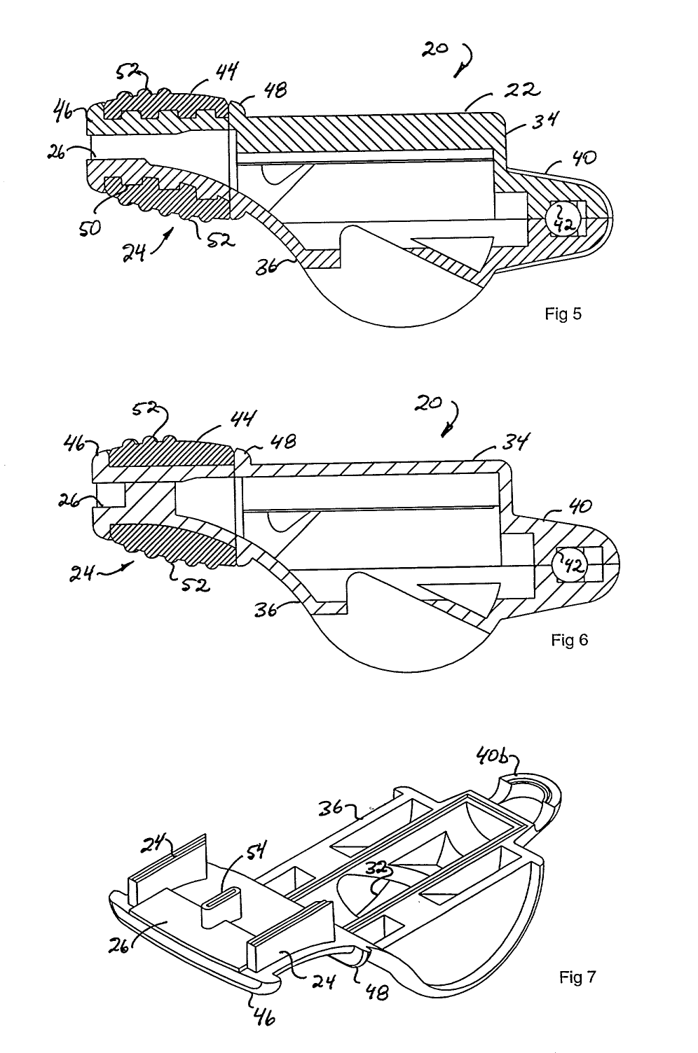

In accordance with the invention, a cushioned mouth grip 44 moulded from an elastomeric material is formed on the mouthpiece 24 into a sleeve which locates between oppositely disposed spaced forward and rearward locating ridges 46, 48 integrally formed in the whistle body 22 and comprising corresponding mating portions 46a, b and 48a, b defined by the top component 34 and the bottom component 36 respectively. The forward ridge 46 is disposed at a proximal end of the mouthpiece 24, and the rearward ridge 48 disposed at a distal end of the mouthpiece 24 have a height which is sufficient to contain the elastomeric material comprising the mouth grip 44, as will be most clearly seen with reference to the cross-sectional views of FIGS. 5 and 6.

The surface of the mouthpiece 24 has a plurality of projections 50 in the form of an array of circular nubs extending outwardly from the whistle body on an exterior surface of the top and bottom components 34, 36 and which are adapted to mate with the cushioning material forming the mouth grip 44.

The mouth grip 44 is preferably a soft elastomeric material or other synthetic rubber like material which could, for example, include a flavoured polyurethane which not only provides a more comfortable grip to the user when the mouthpiece 24 is disposed between a user's teeth but which will also be pleasant to the taste and enjoyable to use. The mouth grip 44 is moulded in situ and will therefore will closely conform to the surface of the mouthpiece 24 and closely adhere to the projections 50. The mouth grip 44 is therefore well located by the ridges 46, 48 and by the projections 50 so that it is less likely to become separated from the whistle body 22 during aggressive use of the whistle.

Conveniently, the outer surface of the mouth grip 44 is formed with a series of parallel corrugations 52 oriented in parallel with the forward and rearward ridges 46, 48 and which not only assist in locating the mouthpiece 24 in the user's mouth but which also provide a distinctive and attractive appearance.

It will be understood that the corrugations are not required as such, as will be seen from the embodiment illustrated in FIG. 8 and that the shape of the corrugations may vary considerably and even be altered to take the form of grooves, depressions or projections and the like, as seen FIGS. 9 to 18. Conveniently, an identifying logo or trademark may be moulded into the mouth grip 44 as shown by the embodiments illustrated in FIGS. 17 and 18.

In accordance with a further feature of the invention, the whistle body includes a web 54 integrally formed with the bottom component 36 and extending into the air inlet passage 26 of the mouthpiece 24 so as to abut against the top component 34. The web 54 is oriented so that its length extends into the air inlet passage 26 and it has a small transverse width which is adapted to minimize any interference with air flow into the air inlet passage. The web 54 is provided to strengthen the mouthpiece 24 so as to minimize the likelihood of the mouthpiece 24 collapsing during aggressive use of the whistle 20. In the above-described embodiment, the web 54 is integrally formed with the bottom component 36 of the whistle 20 but it may of course be formed integrally with the top component 34. It will be noted that the web 54 is somewhat recessed from the proximal end of the mouthpiece 24 and therefore is unobtrusive and does not change in any significant way the appearance of the whistle.

Other variations to the above described embodiment of the invention may be made within the scope of the appended claims as will be apparent to those skilled in the art. Some of these variations have been indicated above, including the shape and configuration of the outward appearance of the mouth grip 44, and the location of the strengthening web 54. As indicated previously, the body of the whistle may change considerably and the invention is not limited to any configuration of the projections 50 provided to better locate the mouth grip 44. Still further variations will be apparent to those skilled in the art.

1. A whistle having a body with a mouthpiece defining an air inlet passage for receiving air therethrough and having cushioning material disposed on said mouthpiece, the mouthpiece having oppositely disposed, spaced forward and rearward locating ridges for locating the cushioning material therebetween.

2. Whistle according to claim 1 in which the cushioning material is in the form of a sleeve having first and second ends disposed adjacent said forward and rearward locating ridges, respectively.

3. Whistle according to claim 1 in which the cushioning material is injection moulded onto the whistle body.

4. Whistle according to claim 1 in which the cushioning material comprises a flavoured material.

5. Whistle according to claim 1 in which the mouthpiece has a plurality of projections on an exterior surface thereof for mating with the cushioning material.

6. Whistle according to claim 1 in which the mouthpiece has an upper body portion spaced from and coupled to a lower body portion to define said air inlet passage, a strengthening web being disposed between said upper and lower body portions and extending between said upper and lower body portions, the web having a length which extends into the air inlet passage and a small transverse width adapted to minimize any interference with air flow into the air inlet passage.
